(19) United States
(12) Patent Application Publication
(10) Pub. No.: US 2010/0088185 A1
(43) Pub. Date: Apr. 8, 2010

(54) UTILIZING EXTRA TEXT MESSAGE SPACE

(75) Inventors: Yandong Wen, Beijing (CN); Liang Chen, Beijing (CN); David P. Vronay, Beijing (CN); Rebecca Jo Sundling, Beijing (CN); Kong-Kat Wong, Beijing (CN); Difei Tang, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,477

(22) Filed: Oct. 3, 2008

(51) Int. Cl. G06Q 30/00; H04W 4/00

(52) U.S. Cl. 705/14.72; 455/466

(57) ABSTRACT

Described is a technology that uses the unused (free) space (that is not occupied by text of a text message) to encode metadata into the text message. The metadata may correspond to an advertisement, a sender's mood, a sender's location, and the like. The inclusion of an advertisement can help reduce the user's cost, while the inclusion of other types of data can reduce the number of messages that need to be sent, without requiring typing in the information. The receiving device processes the metadata to determine an action to take, such as to display an advertisement identified in the metadata, along with the text. The advertisement content may have been previously downloaded in anticipation of its later display.

### BACKGROUND

Text messaging has become an extremely popular way for cellular telephone users to communicate. For many users, however, the cost is expensive, as certain users do not have unlimited text messaging plans, but rather pay per message. Some users have an allowed monthly message limit, but then pay per message once the limit is exceeded.

Short message service, or SMS, (sometimes referred to as simple message service), is a well-known standard for text messaging. In general, SMS uses fixed-size packets to carry the message payload, e.g., (one-hundred-sixty characters in many cases, but possibly seventy characters depending on the implementation). As a result, a per-message paying user pays the same to send a short message such as “hello” as when sending a full or near-full message using all or most of the available packet size.

By way of example, in China, the SMS use fee is charged based upon “blocks” of characters, priced such as 0.1 CNY for one to seventy characters, 0.2 CNY for seventy-one to one-hundred forty characters, and so on. In the United States, the user pays the same fee when sending from one to one-hundred-sixty characters. Unless the user uses up the available characters until the limit, the fee paid by the user is not fully utilized from the users' perspective.

As providing text messaging service to users is highly profitable for service providers, it is not likely that the SMS protocol or this fee model will change anytime soon. Anything that reduces the cost for users is beneficial.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which metadata such as an advertisement is encoded into the free space of a text message for sending with the text of the text message. Other types of metadata include location (e.g., GPS) data, or the sender's mood. As can be readily understood, the inclusion of an advertisement can help reduce the user's cost; the inclusion of other types of data can reduce the number of messages that need to be sent, and/or the amount of typing a user needs to do to convey information.

In one aspect, a text messaging program that determines that free space is available in a text message, works with a metadata processor that selects the metadata to encode into the free space. For example, the metadata may be selected based upon user preference data and/or the amount of free space that remains available after accounting for the text.

In one aspect, when a device receives such a text message that includes encoded metadata, the device parses the metadata, and outputs content corresponding to the metadata. The content may be visible or audible, and may be output for simultaneous viewing with the text, before or after showing the text, in a pop-up display or the like overlaying the text, and so forth. For advertisements, the metadata may be an identifier, that identifies content (e.g., an image) previously downloaded to the receiving device in anticipation of the advertisement metadata being received.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components in a text-messaging device configured to send a text message with metadata encoded into the free space of the message that is not occupied by the text.

FIG. 2 is a block diagram representing example components in a text-messaging device configured to receive a text message with metadata encoded into the free space of the message, and process that metadata to take a corresponding action.

FIG. 3 is a flow diagram showing example steps that may be taken by a SMS program on a sending device to encode metadata into a text message.

FIG. 4 is a flow diagram showing example steps that may be taken by a metadata processor on a sending device to select metadata for encoding into a text message.

FIG. 5 is a flow diagram showing example steps that may be taken by a SMS program on a receiving device to extract and use metadata encoded into a text message.

FIG. 6 is a flow diagram showing example steps that may be taken by a metadata processor on a receiving device to determine which program is associated with received metadata.

FIG. 7 is a flow diagram showing example steps that may be taken by an application associated with received metadata.

FIG. 8 shows an illustrative example of a mobile communications device into which various aspects of the present invention may be incorporated.

### DETAILED DESCRIPTION

Various aspects of the technology described herein are generally directed towards using unused SMS character space (the resource bandwidth paid for by the user) for sending additional information, in a smart and convenient way. The extra bandwidth of SMS can be used for outputting advertisement information from the mobile device operator (or other service provider), from which participating users gets a discount. Other uses include sending location information, e.g., with GPS-enabled devices, sending mood data, and so on. This may be done transparent to the sender, e.g., if the device is appropriately configured, advertisement data, GPS data and/or mood data (e.g., put in once by the user whenever the user's mood changes) may automatically accompany any SMS message as unused space allows.

While many of the examples described herein are directed towards advertising, location data and mood data, it is understood that any type of additional metadata may be sent, such as representing a cursive signature, contact information, a non-commercial image, and so forth. Moreover, the additional metadata that is sent may be, but need not be the actual content that is displayed, but instead may be a reference (e.g., content identifier) to some content to display.

As such, the present invention is not limited to any particular embodiments, aspects, concepts, protocols, formats, structures, functionalities or examples described herein. Rather, any of the embodiments, aspects, concepts, protocols, formats, structures, functionalities or examples described herein are non-limiting, and the present invention may be used various ways that provide benefits and advantages in computing and communications in general.

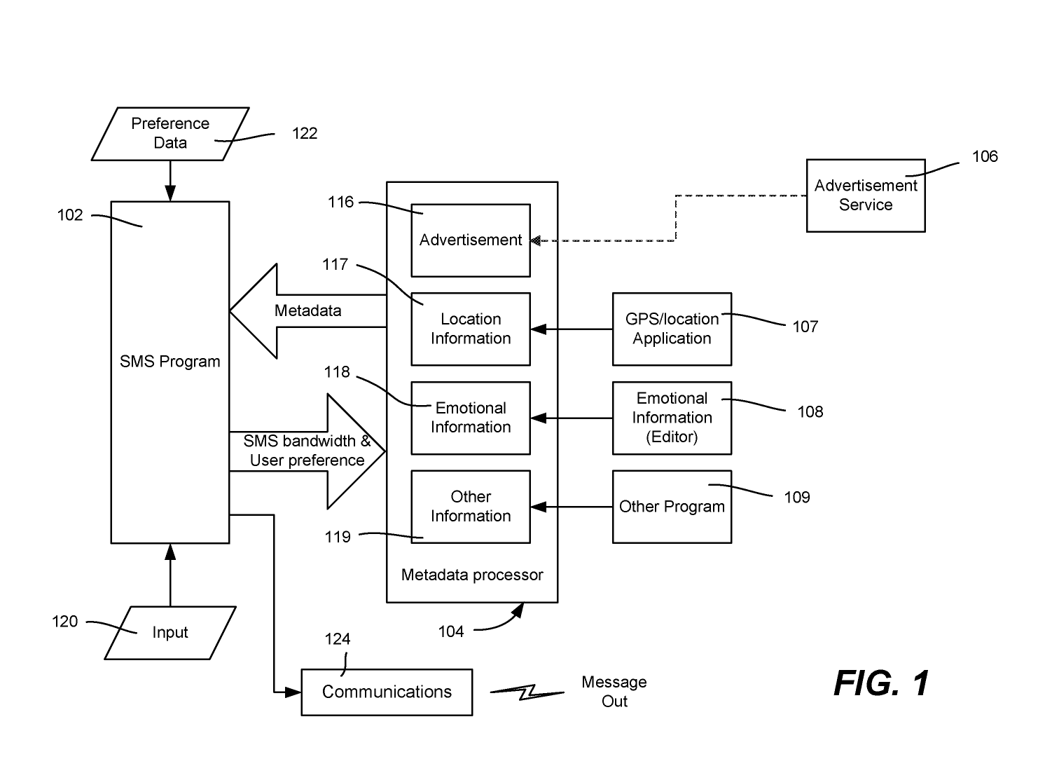

Turning to FIG. 1, there is shown a general block diagram representing example components that may be used in one implementation for sending a message with encoded metadata. Note that any way to encode the metadata may be used, including appending behind or in front of the text, encoding into an eighth bit when only seven bits represent the character (and placing information in the message header that indicates such a scheme is in use) and so forth.

In general, three sets of components work together in this example implementation, namely an SMS program 102, a metadata processor 104, and various applications 106-109 that each generate and/or make use of respective metadata 116-119. Note that while three example applications 106-108 are shown along with an “other” application 109, it is understood that any number of such applications may be present in a given device, and that not all of the applications need be present. Further note that the SMS program and metadata processor can be combined into a single set of logic, however they perform different operations as described below and thus are considered separate entities regardless of how they are physically or logically arranged in a given implementation.

In the sending implementation of FIG. 1, each application provides metadata to the metadata processor that may be encoded into the regular message. Note that the advertisement service 106 may be a remote application, or in part be a local application controlled remotely.

As generally represented in FIG. 1 and in the flow diagram of FIG. 3, the SMS program 102 receives typed text input 120 from the user (step 302 of FIG. 3). When the user presses send, instead of just sending the message, the program 102 counts the characters and determines the amount of free space. The program 102 accesses user preference data 122 (if any), and provides the free space (available “bandwidth”) and user preference data 122 to the metadata processor 104 (step 302 of FIG. 3).

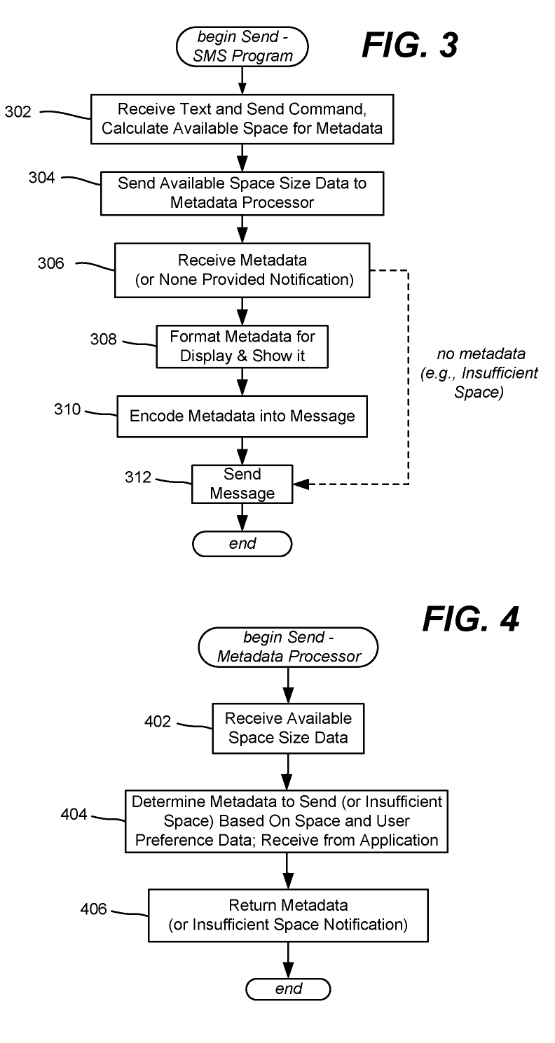

As represented by step 402 of FIG. 4, the metadata processor 104 receives the free space and user preference data 122, and based upon this information, decides (step 404) which kind of metadata information will be returned for encoding in the message. For example, the user may have explicitly specified that GPS location data is to be sent, and thus such data will be returned by the metadata processor 104. As a different example, the metadata processor 104 may not be given an explicit selection, and thus will instead decide whether there is space to send an advertisement (e.g., a reference to some graphics content), and thus save the user money. Note that the metadata processor 104 can track or look up how many text messages have been sent this month, so as to not include advertisements if there is no cost saving. As represented by step 406, the metadata processor 104 returns metadata to encode, or an indication that there is not enough free space available (or similarly that no metadata applies).

Step 306 of FIG. 3 represents the SMS program receiving the metadata to encode (or the indication that there is none). Step 308 optionally formats the metadata for display in some way, so that the user can see what is being sent (e.g., before re-confirming the send). In general, after configuring the mobile device with preference data and possibly using one of the applications to edit the resulting metadata (e.g., enter a current mood), there is no extra typing needed to put this information in the SMS message. GPS information and advertisements may be automatically encoded, as can mood data once set, with user preference data determining whether a particular recipient is designated as one who can receive location data or mood data (e.g., to preserve the sender's privacy).

Step 310 represents encoding the metadata into the message for sending. Step 312 represents sending out the enhanced SMS message containing the metadata information over the normal communications component 124 (which represents any such software and/or hardware).

Note that if at step 306 the metadata processor 104 returns an indication that there is no metadata, step 306 may simply advance to send the message, as shown via the dashed line to step 312. Further note that the SMS program 102 may recognize when there is not enough space to even invoke the metadata processor 104, e.g. the metadata processor 104 may require that there be at least some amount of free space. In such an event, step 302 can likewise jump ahead to step 312 and send the message.

However, encoded metadata may be small, such as a single control code followed by a value that represents mood. Further, one set of metadata may be sent in separate messages to the same recipient; for example, if a user regularly texts another user, partial metadata may be sent with some of the messages, and rebuilt at the recipient into a complete set of metadata for use. Thus, the minimum size requirement for adding metadata may be small.

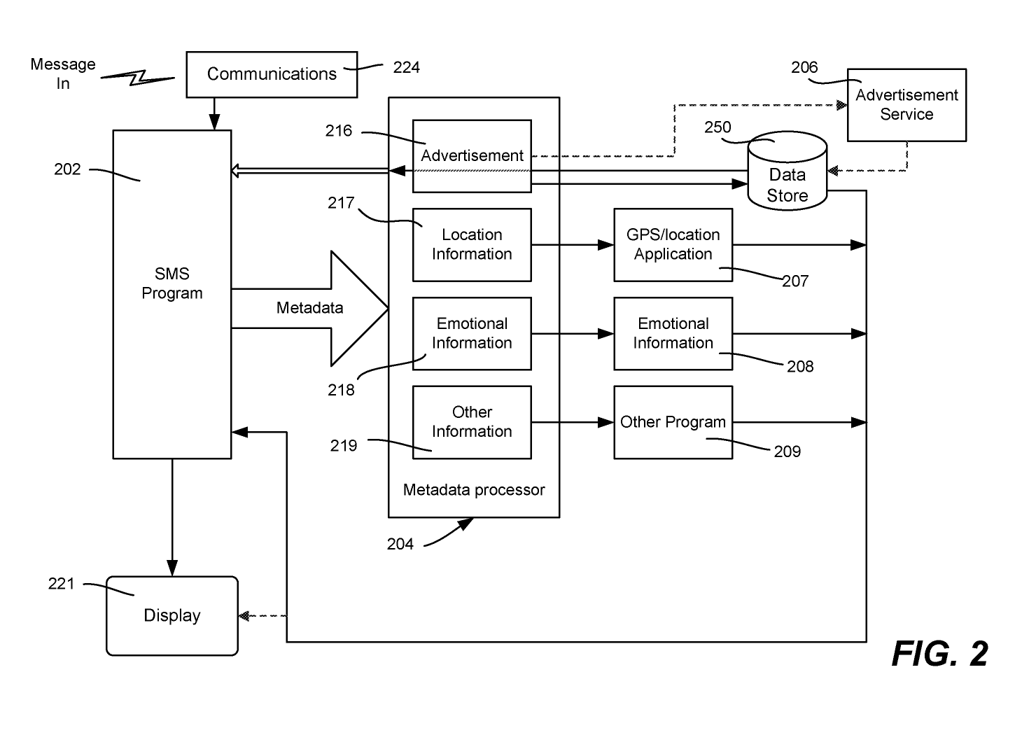

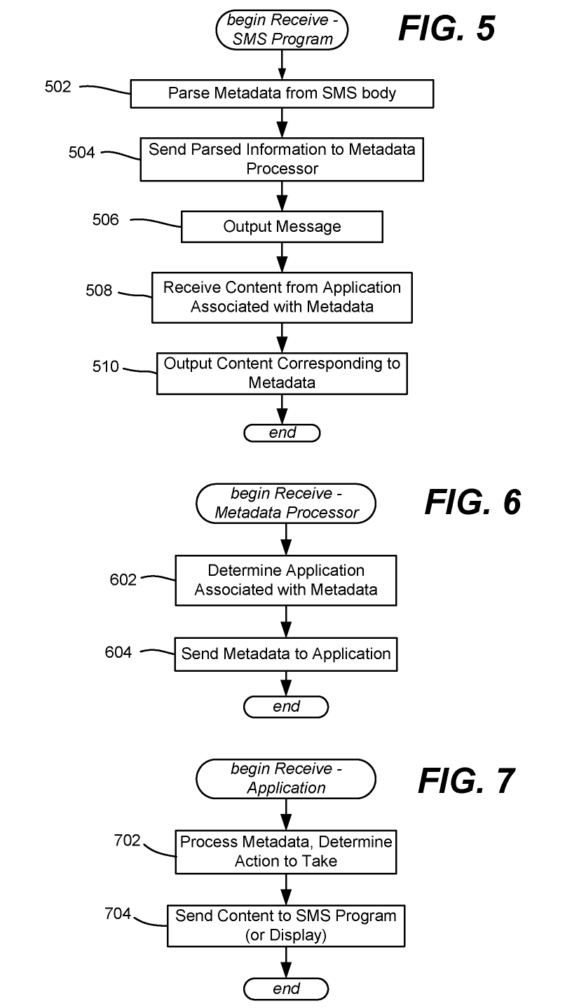

FIG. 2, along with the flow diagrams of FIGS. 5-7, represent example operations taken by a receiving device. For the most part, the components of FIG. 2 are similarly labeled to those of FIG. 1, except that they are labeled “2xx” instead of “1xx” to indicate that at the very least they are on a receiving device operating as such.

As represented in FIGS. 2 and 5, when a message is received by a communications component 224, the SMS program 202 parses the metadata (step 502) from the SMS body, and delivers corresponding information to the metadata processor 204 (step 504). If no such metadata is present, the SMS program 202 acts as a conventional text rendering mechanism as is known today.

As represented in the steps of FIG. 6, the metadata processor 204 determines from the information to which application the metadata applies (step 602), and sends the metadata to that application (step 604).

In turn, as represented in FIG. 7, the selected, associated application processes the metadata to determine an action or set of actions to take. For example, the GPS/location application 207 may produce a map showing where the sender was located at the time the message was sent. The emotional information application can produce a graphic, change the display or text color, produce an audio sound, and so forth to indicate the sender's mood.

As shown in FIG. 2, there are various ways in which the metadata may be used to output corresponding content. For example, the SMS program 202 may be in charge of displaying the message and the content on the display 221, in which case the metadata processor can provide a file or memory location or the like that the SMS program 202 uses to render a combination of the text and any visible content. Alternatively, the SMS program 202 may be told what screen size it has to render text, with the programs given the remaining screen size to directly show content. In another alternative, the content may be shown before and/or after the text message is rendered and exited by the reader, and/or in a pop-up window.

With respect to advertising, once metadata is received at a recipient's device, the advertising may be shown in various ways. As advertisers will pay for showing their content, participating users can reduce their text messaging costs, and/or get other financial incentives, such as to receive valuable merchandise coupons, airline miles, and so forth.

In one aspect, the advertisement, or an identifier corresponding to the advertisement, is placed in the metadata, which is typically not visible. However, devices that do not include metadata-aware text messaging software may show it as readable text. Thus, for such devices, the advertisement identifier may be such that its main theme is still readable as text on devices that are not able to distinguish and hide the control codes, e.g., “<code>Visit Joe's Coffeeshop=s5jk656” where the identifier follows the ‘=’ sign in this example.

For metadata aware devices, the identifier is looked up and used to render a corresponding image. For non-metadata aware devices, the user will at least see the business name, for example.

Advertisements may be downloaded on demand, however this may be slow. Thus, advertising content may be pre-downloaded to a data store 250. For example, advertisers may pay/bid to have a certain metadata advertisement identifiers inserted into text messages on a particular day/time; the advertisers can specify that a visible content image (and/or audio or video clip) corresponding to each identifier be downloaded to as many devices as possible just prior to that day/time, to be cached in anticipation of later use. Note that downloading may take place by internet access, email, or even by an automated telephone call that gets the data. The downloading can be timed for when conventional telephone usage is low and extra over-the-air bandwidth is unused, such as late nights or weekends.

### Exemplary Operating Environment

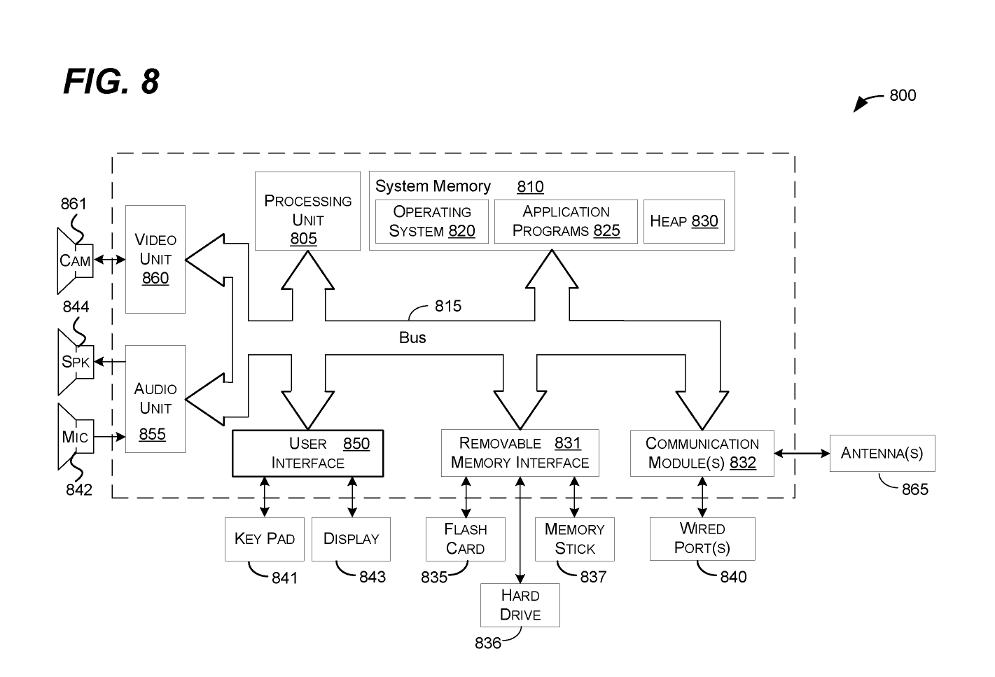

FIG. 8 illustrates an example of a suitable mobile device 800 on which aspects of the subject matter described herein may be implemented. The mobile device 800 is only one example of a device and is not intended to suggest any limitation as to the scope of use or functionality of aspects of the subject matter described herein. Neither should the mobile device 800 be interpreted as having any dependency or requirement relating to any one or combination of components illustrated in the exemplary mobile device 800.

With reference to FIG. 8, an exemplary device for implementing aspects of the subject matter described herein includes a mobile device 800. In some embodiments, the mobile device 800 comprises a cell phone, a handheld device that allows voice communications with others, some other voice communications device, or the like. In these embodiments, the mobile device 800 may be equipped with a camera for taking pictures, although this may not be required in other embodiments. In other embodiments, the mobile device 800 comprises a personal digital assistant (PDA), hand-held gaming device, notebook computer, printer, appliance including a set-top, media center, or other appliance, other mobile devices, or the like. In yet other embodiments, the mobile device 800 may comprise devices that are generally considered non-mobile such as personal computers, servers, or the like.

Components of the mobile device 800 may include, but are not limited to, a processing unit 805, system memory 810, and a bus 815 that couples various system components including the system memory 810 to the processing unit 805. The bus 815 may include any of several types of bus structures including a memory bus, memory controller, a peripheral bus, and a local bus using any of a variety of bus architectures, and the like. The bus 815 allows data to be transmitted between various components of the mobile device 800.

The mobile device 800 may include a variety of computer-readable media. Computer-readable media can be any available media that can be accessed by the mobile device 800 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 800.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, WiFi, WiMAX, and other wireless media. Combinations of any of the above should also be included within the scope of computer-readable media.

The system memory 810 includes computer storage media in the form of volatile and/or nonvolatile memory and may include read only memory (ROM) and random access memory (RAM). On a mobile device such as a cell phone, operating system code 820 is sometimes included in ROM although, in other embodiments, this is not required. Similarly, application programs 825 are often placed in RAM although again, in other embodiments, application programs may be placed in ROM or in other computer-readable memory. The heap 830 provides memory for state associated with the operating system 820 and the application programs 825. For example, the operating system 820 and application programs 825 may store variables and data structures in the heap 830 during their operations.

The mobile device 800 may also include other removable/non-removable, volatile/nonvolatile memory. By way of example, FIG. 8 illustrates a flash card 835, a hard disk drive 836, and a memory stick 837. The hard disk drive 836 may be miniaturized to fit in a memory slot, for example. The mobile device 800 may interface with these types of non-volatile removable memory via a removable memory interface 831, or may be connected via a universal serial bus (USB), IEEE 8394, one or more of the wired port(s) 840, or antenna(s) 865. In these embodiments, the removable memory devices 835-137 may interface with the mobile device via the communications module(s) 832. In some embodiments, not all of these types of memory may be included on a single mobile device. In other embodiments, one or more of these and other types of removable memory may be included on a single mobile device.

In some embodiments, the hard disk drive 836 may be connected in such a way as to be more permanently attached to the mobile device 800. For example, the hard disk drive 836 may be connected to an interface such as parallel advanced technology attachment (PATA), serial advanced technology attachment (SATA) or otherwise, which may be connected to the bus 815. In such embodiments, removing the hard drive may involve removing a cover of the mobile device 800 and removing screws or other fasteners that connect the hard drive 836 to support structures within the mobile device 800.

The removable memory devices 835-837 and their associated computer storage media, discussed above and illustrated in FIG. 8, provide storage of computer-readable instructions, program modules, data structures, and other data for the mobile device 800. For example, the removable memory device or devices 835-837 may store images taken by the mobile device 800, voice recordings, contact information, programs, data for the programs and so forth.

A user may enter commands and information into the mobile device 800 through input devices such as a key pad 841 and the microphone 842. In some embodiments, the display 843 may be touch-sensitive screen and may allow a user to enter commands and information thereon. The key pad 841 and display 843 may be connected to the processing unit 805 through a user input interface 850 that is coupled to the bus 815, but may also be connected by other interface and bus structures, such as the communications module(s) 832 and wired port(s) 840.

A user may communicate with other users via speaking into the microphone 842 and via text messages that are entered on the key pad 841 or a touch sensitive display 843, for example. The audio unit 855 may provide electrical signals to drive the speaker 844 as well as receive and digitize audio signals received from the microphone 842.

The mobile device 800 may include a video unit 860 that provides signals to drive a camera 861. The video unit 860 may also receive images obtained by the camera 861 and provide these images to the processing unit 805 and/or memory included on the mobile device 800. The images obtained by the camera 861 may comprise video, one or more images that do not form a video, or some combination thereof.

The communication module(s) 832 may provide signals to and receive signals from one or more antenna(s) 865. One of the antenna(s) 865 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 800 may connect to one or more remote devices. The remote devices may include a personal computer, a server, a router, a network PC, a cell phone, a peer device or other common network node, and typically includes many or all of the elements described above relative to the mobile device 800.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a mobile communications environment, a method comprising, determining that free space is available in a text message, and encoding metadata into the free space for sending with text of the text message.

2. The method of claim 1 wherein the metadata is associated with an advertisement.

3. The method of claim 2 wherein the metadata identifies the advertisement, in which the advertisement comprises content downloaded to a recipient device for output on the recipient device.

4. The method of claim 1 wherein the metadata is associated with a mood of a sender of the text message.

5. The method of claim 1 wherein the metadata is associated with a location of a sender of the text message.

6. The method of claim 1 further comprising, determining which metadata of a plurality of sets of metadata is to be encoded into the free space.

7. The method of claim 6 wherein determining which metadata is to be encoded comprises evaluating a size of the free space.

8. The method of claim 6 wherein determining which metadata is to be encoded comprises evaluating user preference data.

9. In device in a communications environment that is configured to transmit text messages, a system comprising, a text messaging program that determines that free space is available in a text message, and a metadata processor that determines selected metadata to encode into the free space, the text messaging program coupled to the metadata processor to encode the selected metadata into the free space for sending with text of the text message.

10. The system of claim 9 wherein the selected metadata identifies an advertisement.

11. The system of claim 9 further comprising a mechanism by which information corresponding to a mood of a sender of the text message is selected as the metadata.

12. The system of claim 9 further comprising a location sensing mechanism by which information corresponding to a location of a sender of the text message is selected as the metadata.

13. The system of claim 9 wherein the metadata determines the selected metadata based upon user preference data or an amount of free space, or both user preference data and an amount of free space.

14. In a mobile communications environment, a method comprising, receiving a text message, outputting text of the message, determining that the text message includes metadata encoded into space that is not used for the text of the message, parsing the metadata, and outputting content corresponding to the metadata.

15. The method of claim 14 wherein the content corresponding to the metadata comprises a visible or audible advertisement, or both a visible and audible advertisement.

16. The method of claim 15 wherein the metadata identifies the advertisement from among a plurality of advertisements.

17. The method of claim 15 further comprising, caching the advertisement in anticipation of use prior to receiving the text message that includes the metadata corresponding to the advertisement.

18. The method of claim 14 wherein the content corresponding to the metadata comprises a visible or audible indication of a mood of a sender of the text message, or both a visible and audible advertisement of the mood.

19. The method of claim 14 wherein the content corresponding to the metadata comprises a visible or audible indication of a location of a sender of the text.

20. The method of claim 14 wherein outputting the content corresponding to the metadata comprises displaying visible information representative of the content for viewing while the text of the message is visible.
